(19) United States
(12) Patent Application Publication
(10) Pub. No.: US 2026/0308963 A1
(43) Pub. Date: Oct. 8, 2026

(54) HINGE ELEMENT AND METHOD FOR MOUNTING HINGE ELEMENT

(71) Applicant: TURNA D.O.O., Sostanj (SI)

(72) Inventors: Peter Kolar, Polzela (SI); Ales Plesnik, Sostanj (SI)

(21) Appl. No.: 19/481,700

(22) PCT Filed: Nov. 3, 2025
(86) PCT No.: PCT/SI2024/050017

§ 371 Date: Nov. 5, 2025

(30) Foreign Application Priority Data
May 5, 2023 (SI) P-202300062

(51) Int. Cl. E05F 1/12

(52) U.S. Cl. CPC E05F 1/1253; E05Y 2600/53; E05Y 2800/205; E05Y 2800/236; E05Y 2900/308

(57) ABSTRACT

The subject of invention is hinge element and method for mounting hinge element, solving technical problem of installing hinge element in appliance. Due to operation of push element (7) with matching element of push element (8) installed in mechanism bracket (4) and hinge guide (1), hinge element can be mounted separately in appliance. Components installed in mechanism bracket (4) are mounted in appliance during assembly. Hinge element comprises at least hinge guide (1), matching element of hinge guide (2), mechanism bracket (4), hinge body (5), hinge latch (6), push element (7) and matching element of push element (8). When inserting and pushing guide into hole on appliance, matching element of push element (8) slides/rolls on hinge guide (1) until matching element of hinge guide (2) and matching element of push element (8) coincide. Small inclination of inclined part of hinge guide (3) results in low push force, so no additional tools are needed to attach hinge.

### FIELD OF TECHNOLOGY

Hinge element; mounting of hinge element; push element; hinge for opening and closing cabinet doors; assembly without dedicated tools

### TECHNICAL PROBLEM

Hinge elements are built into the walls of appliances. The walls of the refrigerating and heating appliances must be insulated as much as possible to ensure better energy efficiency and minimise heat losses of the appliance.

When installing the hinges, especially complex hinges, such as motor-driven hinges, the hinges are inserted into the appliances through holes provided for this purpose. After the hinge has been inserted, it has to be turned to ensure proper installation, which means that a large part of the wall in which the hinge is installed is of limited use for installing the insulation material.

This invention presents the hinge and the installation of the presented hinge in a way that the hinge is installed separately from other components connected with the hinge and the hinge does not need to be turned in the wall of the appliance, which means that a significantly greater amount of thermal insulation can be installed in the walls of appliances to improve the energy efficiency of the product, thus increasing its market value.

### STATE OF THE ART

Hinges for manual opening and closing cabinet doors and hinges for motor-driven opening and closing of doors are generally well known, since they have been on the market for a long time.

With known solutions, when installing the hinges, the door hinge, including any associated door drive elements, is installed as part of the oven structure assembly.

As a result, the installation of hinges requires more space in the walls of the appliance. In the case of heating or cooling appliances, it is sensible to insulate the walls of the appliance. When hinges with all the associated elements are retrofitted into the appliance walls, the thickness of the insulation in the appliance walls is limited.

The device according to the invention provides a solution to the technical deficiencies described.

### DESCRIPTION OF NEW INVENTION

The subject of the invention is the hinge element and method for mounting hinge element, which solve the technical problem of installing the hinge element in the appliance.

The operation of the push element with the matching element of the push element installed in the mechanism bracket and the corresponding hinge guide allows the hinge to be mounted separately in the appliance. The components installed in the mechanism bracket are mounted in the appliance during its assembly, prior to the final assembly of the appliance body.

The hinge element comprises at least a hinge guide, a matching element of the hinge guide, a mechanism bracket, a hinge body, a hinge latch, a push element and a matching element of the push element.

The end of the hinge guide is preferably constructed as an inclined part of the hinge guide or rounding of the hinge guide to facilitate hinge mounting.

First, at the time of production of the appliance, the mechanism bracket with all its components is mounted inside the appliance. In the case of a motor-driven hinge, the motor and other associated parts are installed in the appliance before the body is closed, after which the hinge is pushed through the corresponding hole in the wall of the appliance by means a linear motion.

The hinge is pushed into the hole in the element until the matching element of the hinge guide and the matching element of the push element lock in position. The push element pushes the matching element of the push element. The push element and the matching element of the push element can be constructed from one, two or more parts, which, however, does not limit the essence of the invention. The matching element of the push element is preferably constructed as a roller. When inserting the guide and pushing the guide into the hole on the appliance, the matching element slides or rolls on the hinge guide until the matching element of the hinge guide and the matching element of the push element coincide.

Due to the small angle of inclination of the inclined part of the hinge guide, the push force is sufficiently low to allow the assembler to push the hinge into place without using additional tools.

The mechanism bracket with the appropriate components fitted and the hinge are supplied in such a condition that when the hinge is pushed into place, the fixing bores on the hinge body are aligned with the fixing bores on the mechanism bracket, after which the hinge is secured in the appliance through both of these bores with the hinge fasteners, preferably with screws. When the fasteners, preferably the screws, are mounted through the mechanism bracket into the hinge body, the hinge assembly is completed and the hinge is functional. The assembly is carried out without the need for additional tools or temporary locking elements.

A support element of the hinge guide, preferably in the form of a support roller, is provided below the hinge guide, preferably in the vicinity of the push element, so that the hinge guide slides or rolls on the support element of the hinge guide. The support element generates a reaction force on the hinge guide in the opposite direction of the force of the push element, creating a force balance.

When mounting the hinge element, the rear part of the hinge guide, which is preferably constructed as an inclined part of the hinge guide or in the form of a rounding, first comes into contact with the matching element of the push element. When the matching element of the push element moves, it follows the height of the hinge guide. In this position, due to the inclination of the hinge guide, a certain amount of force is also transferred in the direction of the hinge guide. Due to the small angle of inclination of the inclined part of the hinge guide, this force is sufficiently low, so that it is not detected by the user.

The hinge body is the base of the hinge structure to which other components are attached and against which other components move. The hinge latch is connected to the hinge body through a swivel link which forms the pivot point of the door of the final appliance. Depending on the hinge implementation, the hinge latch and the hinge body are connected to the oven body and door. The hinge lock can be connected to the hinge latch through a swivel link and allows the movement of the hinge to be blocked for mounting purposes.

The essence of the invention is further explained below with the description of the embodiment and attached figures, whereby the figures are part of this patent application and show the following:

FIG. 1 shows the hinge guide 1, the matching element of the hinge guide 2, the inclined part of the hinge guide 3, the mechanism bracket 4, the hinge body 5, the hinge latch 6, the push element 7, the matching element of the push element 8, the support element of the hinge guide 9 and the fixing bore on the hinge body 10.

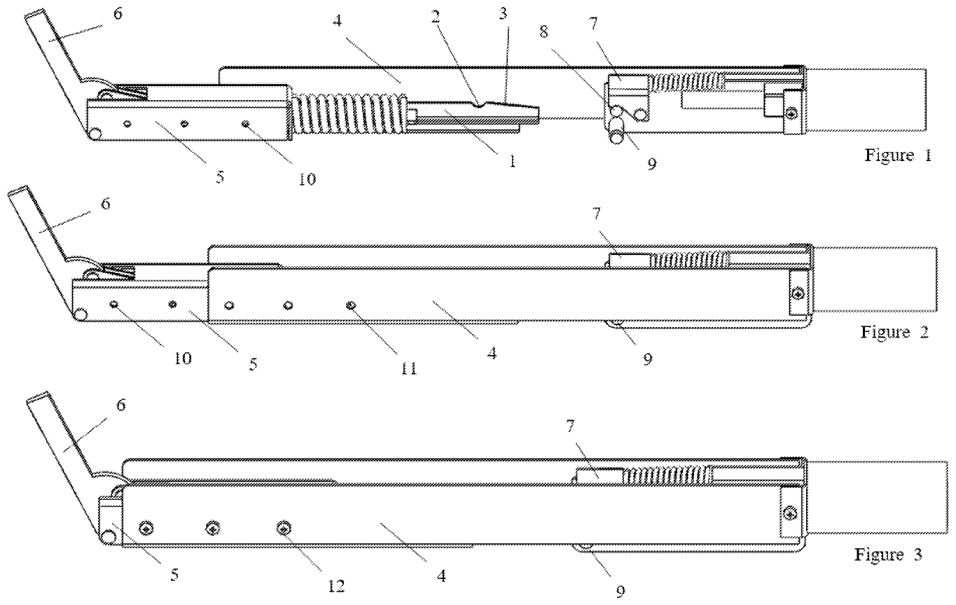

FIG. 2 shows the mechanism bracket 4, the hinge body 5, the hinge latch 6, the push element 7, the support element of the hinge guide 9, the fixing bore on the hinge body 10 and the fixing bore on the mechanism body 11.

FIG. 3 shows the mechanism bracket 4, the hinge body 5, the hinge latch 6, the push element 7, the support element 9 and the hinge fastener 12.

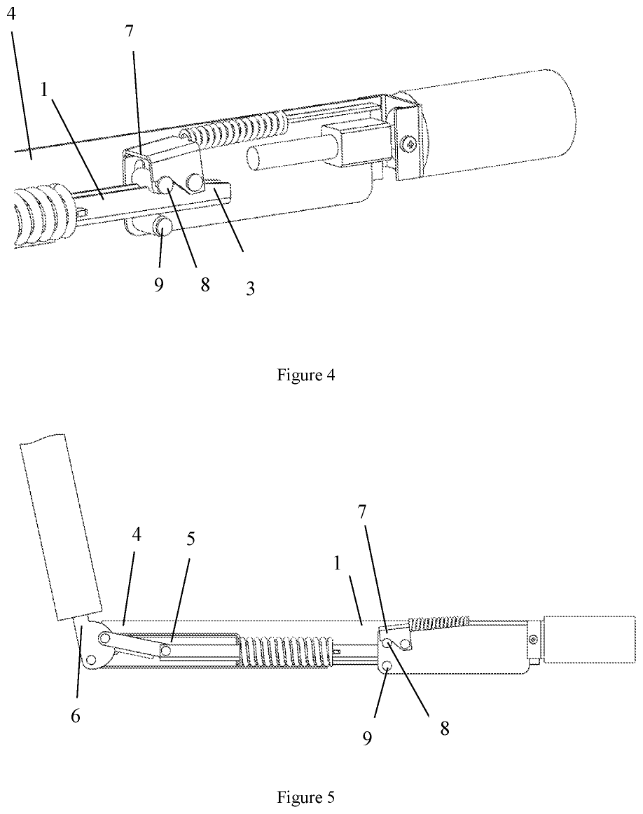

FIG. 4 shows the hinge guide 1, the inclined part of the hinge guide 3, the mechanism bracket 4, the push element 7, the matching element of the push element 8 and the support element 9.

FIG. 5 shows the hinge guide 1, the mechanism bracket 4, the hinge body 5, the hinge latch 6, the push element 7, the matching element of the push element 8 and the support element of the hinge guide 9.

### EXEMPLARY EMBODIMENT

The operation of the push element 7 with the matching element of the push element 8 installed in the mechanism bracket 4 and the corresponding hinge guide 1 allows the hinge element to be mounted separately in the appliance. The components installed in the mechanism bracket 4 are mounted in the appliance during its assembly, prior to the final assembly of the appliance body.

The hinge element comprises at least the hinge guide 1, the matching element of the hinge guide 2, the mechanism bracket 4, the hinge body 5, the hinge latch 6, the push element 7 and the matching element of the push element 8. The end of the hinge guide 1 is constructed as an inclined part of the hinge guide 3 to facilitate hinge mounting.

First, at the time of production of the appliance, the mechanism bracket 4 with all its components is mounted inside the appliance. In the case of a motor-driven hinge, the motor and other associated parts are installed in the hinge before the body is closed, after which the hinge is pushed through the corresponding hole in the wall of the appliance by a linear motion.

The hinge is pushed into the hole in the element until the matching element of the hinge guide 2 and the matching element of the push element 8 lock in position. The push element 7 pushes the matching element of the push element 8. The push element 7 and the matching element of the push element 8 are constructed from two parts. The matching element of the push element 8 is constructed as a roller. When inserting the guide and pushing the guide into the hole on the appliance, the matching element of the push element 8 rolls on the hinge guide 1 until the matching element of the hinge guide 2 and the matching element of the push element 8 coincide.

Due to the small angle of inclination of the inclined part of the hinge guide 3, the push force is sufficiently low to allow the assembler to push the hinge into place without using additional tools.

The mechanism bracket 4 with the appropriate components fitted and the hinge are supplied in such a condition that when the hinge is pushed into the position where the matching element of the push element 8 and the matching element of the hinge guide 2 match, the fixing bores on the hinge body 10 are aligned with the fixing bores on the mechanism bracket 11, after which the hinge is secured in the appliance through both of these bores with the hinge fasteners 12, constructed in the form of screws. When the screws are mounted through the mechanism bracket into the hinge body, the hinge assembly is completed and the hinge is functional. The assembly is carried out without the need for additional tools or temporary locking elements.

A support roller is constructed under the hinge guide 1 in the vicinity of the push element.

When mounting the hinge element, the rear part of the hinge guide 1, which is constructed as an inclined part of the hinge guide 3, first comes into contact with the matching element of the push element 8. When the matching element of the push element 8 moves, it follows the height of the hinge guide 1.

The hinge body 5 is the base of the hinge structure to which other components are attached and against which other components move. The hinge latch 6 is connected to the hinge body 5 by a swivel link which forms the pivot point of the door of the final appliance.

Once the structure of the appliance is complete, a hinge element is mounted from the front by simply pushing it through the opening in the front wall of the appliance. The inclined part of the hinge guide 3 gradually lifts the push element 7, which is why the required push force is relatively small or sufficiently low to ensure manual assembly.

It is self-evident that the above described invention can be also used in other particular form not changing the substance of the invention.

1. The hinge element characterised in that it comprises at least a hinge guide (1), a matching element of the hinge guide (2), a mechanism bracket (4), a hinge body (5), a hinge latch (6), a push element (7) and a matching element of the push element (8).

2. The device according to claim 1, characterised in that it the matching element of the push element (8) is constructed as a clutch roller.

3. The device according to claim 1, characterised in that the end of the hinge guide (1) is constructed as an inclined part of the hinge guide (3).

4. The device according to claim 1, characterised in that the end of the hinge guide (1) is constructed as a rounded part of the hinge guide (1).

5. The device according to claim 1, characterised in that the support element (9) of the hinge guide (1) is constructed under the hinge guide.

6. The device according to claim 1, characterised in that the support element (9) is constructed as a support roller.

7. The device according to claim 1, characterised in that the rear part of the hinge guide (1) is constructed as an inclined part of the hinge guide (3).

8. The method for mounting hinge element, characterised in that the hinge element is pushed into the hole in the element until the matching element of the hinge guide (2) and the matching element of the push element (8) lock in position, whereby the push element (7) pushes the matching element of the push element (8).

9. The method according to claim 8, characterised in that the components installed in the mechanism bracket (4) are mounted in the appliance during its assembly, prior to the final assembly of the appliance body.

10. The method according to claim 8, characterised in that in the case of a motor-driven hinge, the motor and other associated parts are installed in the mechanism bracket (4) before the body is closed, after which the hinge is pushed through the corresponding hole in the wall of the appliance by means a linear motion.

11. The method according to claim 8, characterised in that the mechanism bracket (4) with the appropriate components fitted and the hinge element are supplied in such a condition that when the hinge element is pushed into place, the fixing bores on the hinge body (10) are aligned with the fixing bores on the mechanism bracket (11), after which the hinge element is secured in the appliance through both of these bores with the hinge fasteners (12).

12. The method according to claim 8, characterised in that when mounting the hinge element, the rear part of the hinge guide (1) first comes into contact with the matching element of the push element (8).
